(19) United States
(12) Patent Application Publication
(10) Pub. No.: US 2006/0010084 A1
(43) Pub. Date: Jan. 12, 2006

(54) Electronic postage marker

(76) Inventor: Martin Paping, Vaucresson (FR)

Correspondence Address: PERMAN & GREEN, 425 POST ROAD, FAIRFIELD, CT, 06824, US

(21) Appl. No.: 11/177,223

(22) Filed: Jul. 8, 2005

(30) Foreign Application Priority Data
Jul. 8, 2004 (FR) FR 04 07606

(51) Int. Cl. G06F 17/00

(52) U.S. Cl. 705/408

(57) ABSTRACT

An electronic postage marker for printing data on a mail item, the electronic postage marker including: disposable ink jet print means for spraying droplets of ink through an opening in a housing body onto the mail item; displacement means for displacing the print means along the opening; position coding means for determining the position of the print means; processor means including communications means for receiving, in secure manner, the data to be printed, decoder means for decoding the secure data, program memory means, and data memory means; display means for displaying the data to be printed before it is printed on the mail item; and data input means for acting in association with he display means to confirm the commands from the processor means.

### TECHNICAL FIELD

The present invention relates exclusively to the field of mail handling, and it relates more particularly to an electronic system for “franking” mail, i.e. for affixing a postage amount to mail, the system being in the form of an inkable marker.

### PRIOR ART

U.S. Pat. No. 5,271,322 discloses an inkable marker for marking a postage stamp on an item of mail such as a letter or a parcel. That franking system is particularly intended for small businesses or private individuals having volumes of mail that are too small to justify using a postage meter or “franking machine”. However, that system suffers from the drawback of being usable for marking only a given number of postal imprints, beyond which the marker self-destructs and must therefore be discarded.

### OBJECT AND DEFINITION OF THE INVENTION

An object of the present invention is thus to provide an electronic postage marker that can print an unlimited number of postal imprints in fully secure manner. Another object of the invention is to make it possible to print other data such as the destination address, service messages, authentication codes, etc., or any other image or graphics data.

Thus, the invention provides an electronic postage marker for printing data on a mail item, said electronic postage marker comprising:

a substantially rectangular housing body provided with an opening in one of its side faces;

disposable ink jet print means disposed in said housing body for spraying droplets of ink through said opening onto the mail item;

displacement means disposed inside said housing casing for displacing said print means along said opening;

position coding means disposed in said housing body for determining the position of said print means along said opening;

processor means disposed in said housing body for controlling the print means as a function of the position of the displacement means and of said data to be printed on said mail item;

said processor means comprising:
communications means for receiving, in secure manner, said data to be printed;
decoder means for decoding the data to be printed that is received at said communications means;
program memory means for storing control instructions for controlling the print means; and

data memory means for temporarily storing said data to be printed, prior to printing;

display means for displaying the data to be printed before it is printed on said mail item;

data input means for acting in association with said display means to confirm the commands from said processor means; and

rechargeable power supply means disposed in said housing.

Said data to be printed is chosen from the following data: postal imprint, slogan, destination address, authentication data, service data, or any other image data.

With this marker, it is possible to stamp all correspondence very simply without using a costly postage meter. The secure communications link makes it possible to guarantee interchange of postal data while providing easy connection to the site of the dealer or of the postal administration, in particular for the purpose of issuing new credit to the marker, changing postal charges, etc. or indeed to any other external network, or to any other specialized mail peripheral, meter, or machine.

Advantageously, said data memory means are of the backed-up type and comprise secure accounting means, in particular a down-counter and an up-counter.

Preferably, said position coding means comprise an optical coder serving to co-operate with a screen-printed coding wheel or strip, and, depending on the embodiment considered, said communications means may comprise radiofrequency long-distance wireless communications means and/or infrared or radiofrequency short-distance wireless communications means.

Advantageously, said display means comprise a liquid crystal graphics screen, and said data input means comprise a keypad having at least three keys for running the following functions: next, back, and confirm.

Preferably, said processor means further comprise decoder means for decoding the data to be printed that is received at said communications means. Said decoder means comprise means for deciphering said received data on the basis of a secret key stored in the processor means, or else means for validating a signature accompanying said received data, on the basis of a secret key stored in the processor means.

### BRIEF DESCRIPTION OF THE DRAWINGS

The invention will be better understood on reading the following detailed description accompanied by illustrative and non-limiting examples with reference to the following figures, in which:

FIGS. 1 and 2 show two examples of architecture for mail franking systems incorporating an electronic postage marker of the invention;

FIGS. 3 and 4 are views respectively in longitudinal section and in cross-section, showing a first embodiment of an electronic postage marker of the invention;

FIGS. 5 and 6 are views respectively in longitudinal section and in cross-section, showing a second embodiment of an electronic postage marker of the invention;

FIG. 7 is a diagrammatic view showing the electronic structure of the electronic postage marker of the invention; and

FIG. 8 is a flow chart showing the printing cycle of a postal imprint of the invention.

### DETAILED DESCRIPTION OF EMBODIMENTS

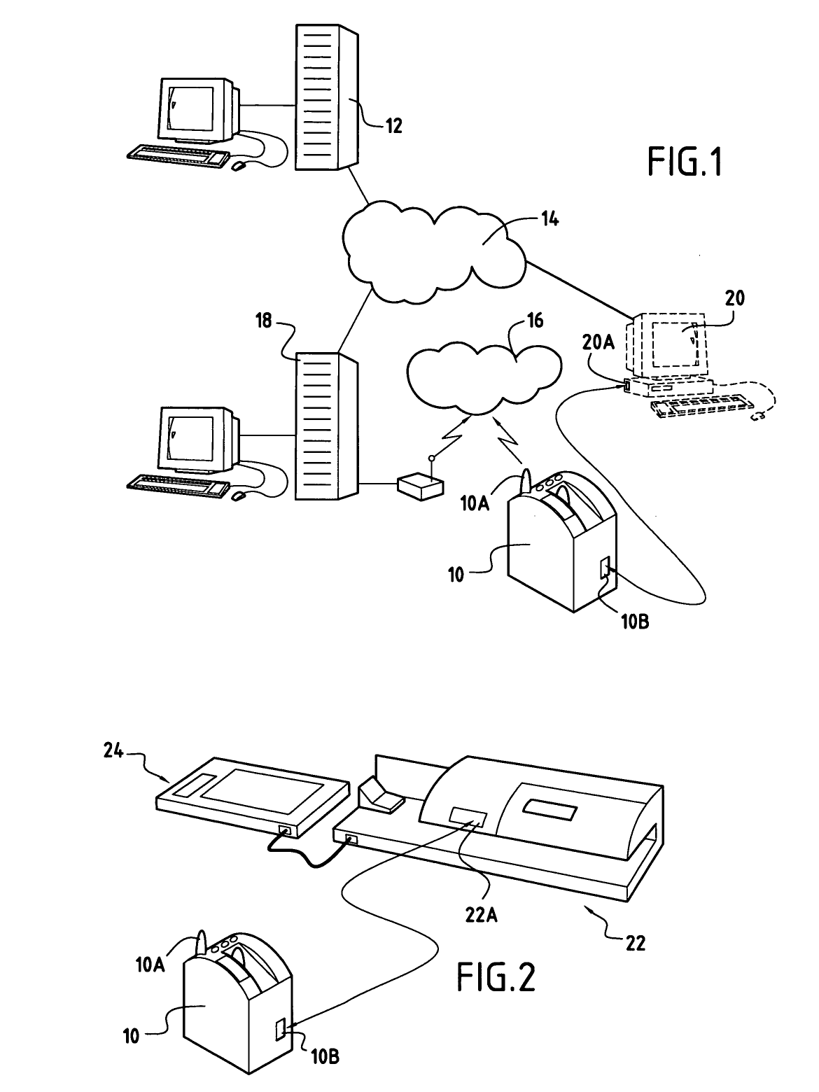

Reference is made firstly to FIG. 1 which shows a preferred example of overall architecture for a mail franking system incorporating an electronic postage marker of the invention. Such a system, which offers the advantage of not needing any equipment other than the electronic postage marker, is thus well suited to use by (private) individuals, and it implements both a telecommunications network such as the Internet, and a mobile radio-communications network, such as the General Packet Radio Service (GPRS) network or the Universal Mobile Telecommunications System (UMTS) network. The electronic postage marker 10, which incorporates a secure print module for securely printing a postal imprint, also includes long-distance radio-communications means for enabling it to be connected to a remote computer server 12 of the postal administration or of the dealer for the electronic postage marker. This link between the postage marker and the remote computer server makes it possible in particular to issue new credit to the postage marker once its credit has been used up and said link is conventionally established from its long-distance radiofrequency transmission means 10A over the Internet 14 and over the GPRS/UMTS network 16 via an interconnection server 18 making it possible to pass data between the wireless network 16 and the wired network 14.

Another embodiment of overall architecture for a mail franking system implementing an electronic postage marker of the invention is shown in dashed lines in FIG. 1. This system is more particularly adapted to one-person businesses or to very small businesses that are already equipped with a computer unit of the personal computer (PC) type, for example. In such a system, the electronic postage marker 10 which also includes short-distance wireless transmission means 10B that are infrared (e.g. Firewire) or radiofrequency (Bluetooth or IEEE802.11x, for example), and that can be connected directly to a personal computer 20 of the business that is provided with a corresponding interface 20A, and that is itself connected directly to the Internet 14. It should be noted that, in this configuration, the personal computer can constitute one element of an open franking system incorporating, for example, postal weighing scales and a folder/inserter that are not shown.

FIG. 2 shows how the postage marker of the invention is incorporated into another example of architecture for a franking system including a postage meter 22 and postal weighing scales 24. The postage meter which, as is known, includes secure accounting means, is preferably not provided with a label dispenser because the postage marker makes it possible to mark thick envelopes or indeed parcels that cannot be handled directly by the postage meter (typically, a postage meter is limited to printing envelopes of thickness smaller than 16 millimeters (mm)). The link between the postage meter and the electronic postage marker is preferably established as above by means of the wireless communications interface 10B of the postage marker that co-operates with a corresponding interface 22A of the postage meter. However, a conventional wired link (not shown) could also be considered in such a configuration.

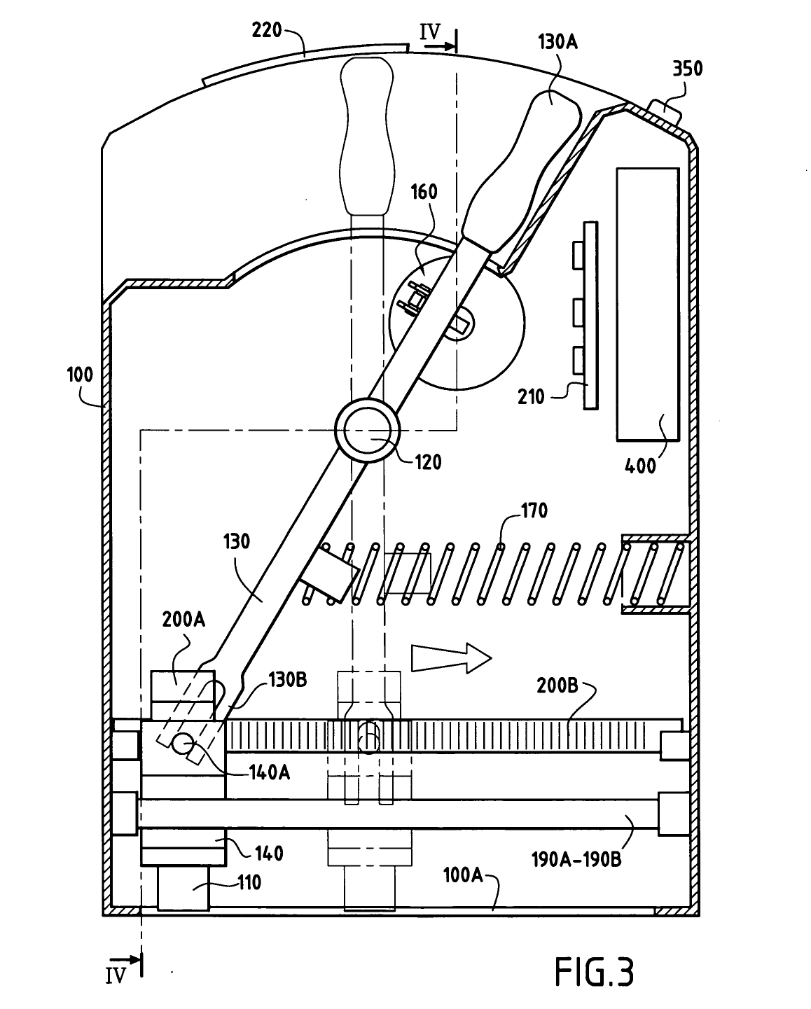

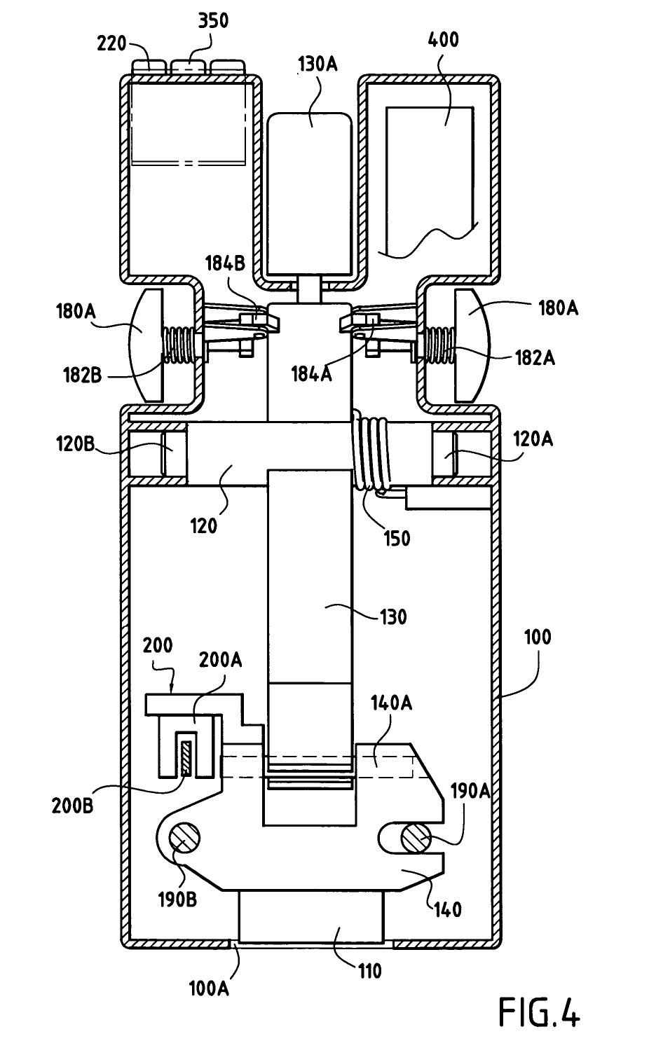

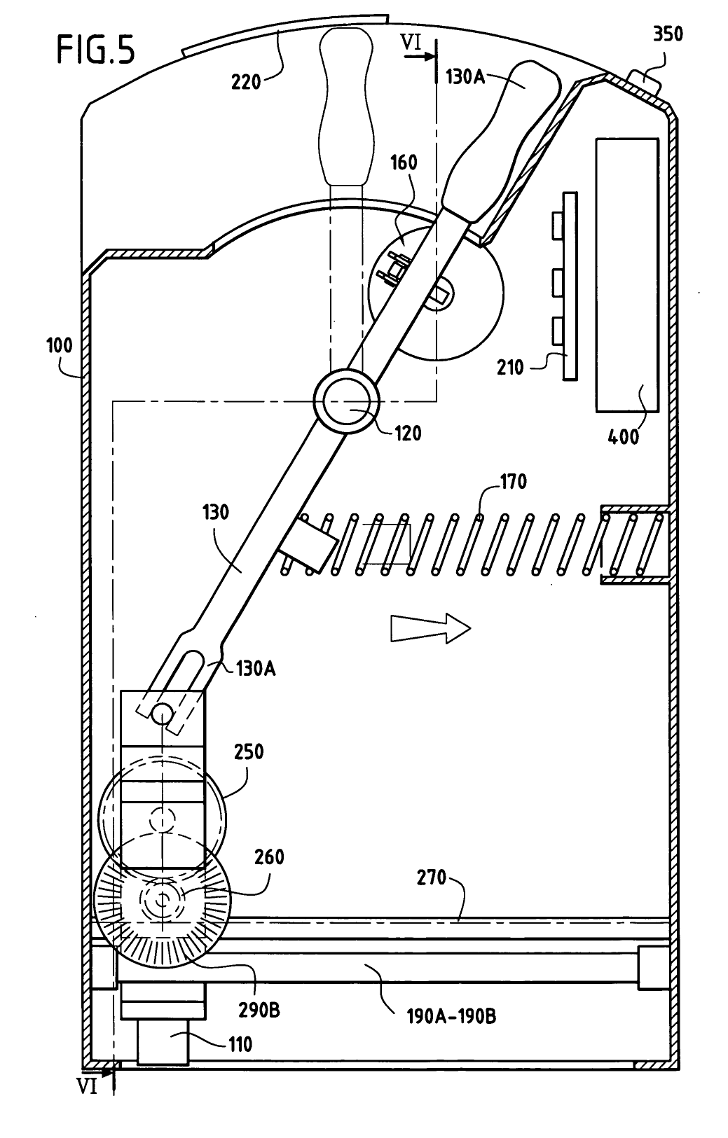

A first embodiment of an electronic postage marker of the invention is shown in FIGS. 3 and 4.

In a substantially rectangular housing 100, this postage meter includes disposable print means of the ink-jet type 110 that are mounted to move in a longitudinal direction of the housing through a low opening in said housing 100A, and that serve to print a postal imprint on any medium disposed facing said opening. The disposable print means are advantageously constituted by a Hewlett Packard standard cartridge having two rows of nozzles.

Said print means are caused to move by tilting a drive lever 130 about a pivot pin 120 from a rest position, the first end of the drive lever having a handle 130A, and its second end, opposite from the first end, having a fork 130B that engages over a hinge pin 140A of a carriage 140 for supporting the ink-jet print means.

A torsion spring 150 that is compressed when the drive lever is cocked by the user of the marker is wound around the pivot pin 120 that is secured to the housing via its two ends 120A, 120B. Once cocked, the drive lever 130 is held automatically in position by a locking/unlocking mechanism 160. Action by the user on said mechanism enables the drive lever to be released and to be returned to its rest position under the action of the torsion spring 150 relaxing. A compensation spring 170 mounted between the drive lever and the housing makes it possible to compensate for the torsion spring relaxing suddenly and to guarantee that the lever moves linearly over its return stroke to its rest position.

The locking/unlocking mechanism 160 is advantageously constituted by two push buttons 180A, 180B mounted on springs 182A, 182B on either side of the lever, and whose respective ends act on respective hinged arms 184A, 184B in engagement on said lever, action on the push buttons causing the arms of the drive lever to be disengaged, thereby releasing said drive lever.

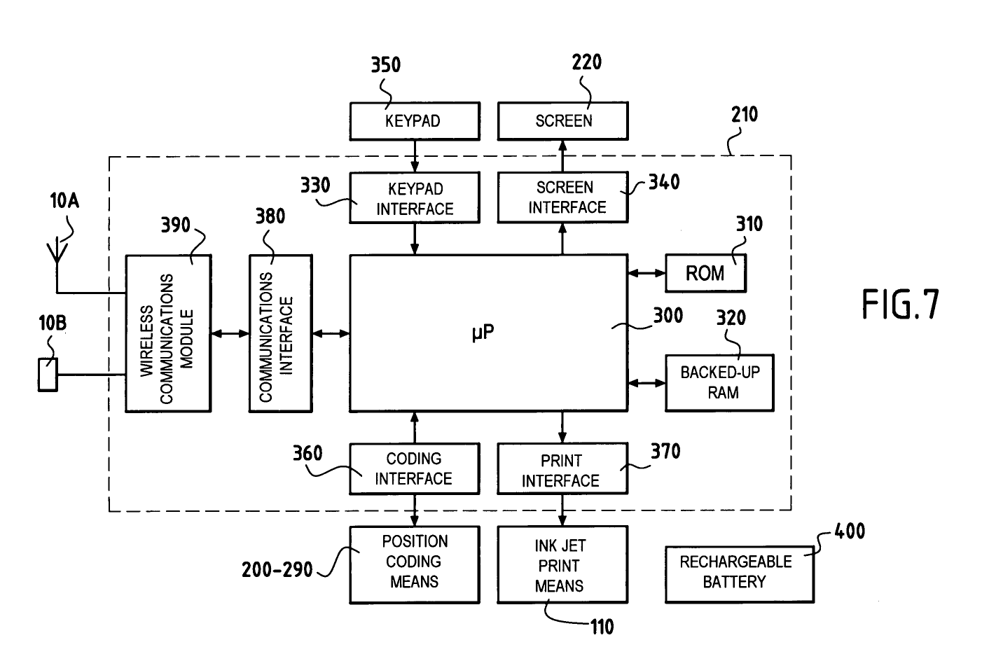

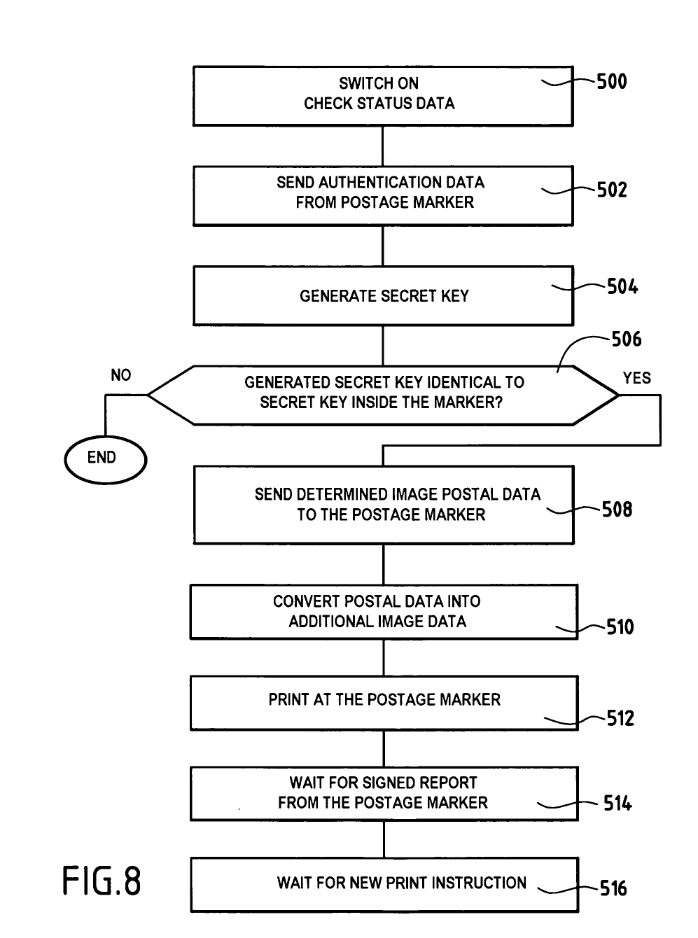

Under action from the drive lever, the carriage for supporting the print module 140 can slide on two parallel longitudinal guides 190A, 190B that are secured to the housing at their ends, and said carriage is provided with position coding means 200 for coding its position, which coding means comprise an optical coder 200A fastened to the support carriage and serving to co-operate with a screen-printed coding strip 200B mounted parallel to the longitudinal guides. The coding means 200, which make it possible to determine at any time the position of the print means while they are moving along the low opening in the housing, are connected to processor means 210 (described in detail below with reference to FIG. 7) which are themselves connected to the print means 110, said processor means causing the ink ejection nozzles to move as a function of the data to be printed, e.g. postal imprints or other service or address data, which data is displayed on a display screen 220 of the electronic postage marker prior to printing (in order to make the drawings clearer, the electrical links with the processor means are not shown).

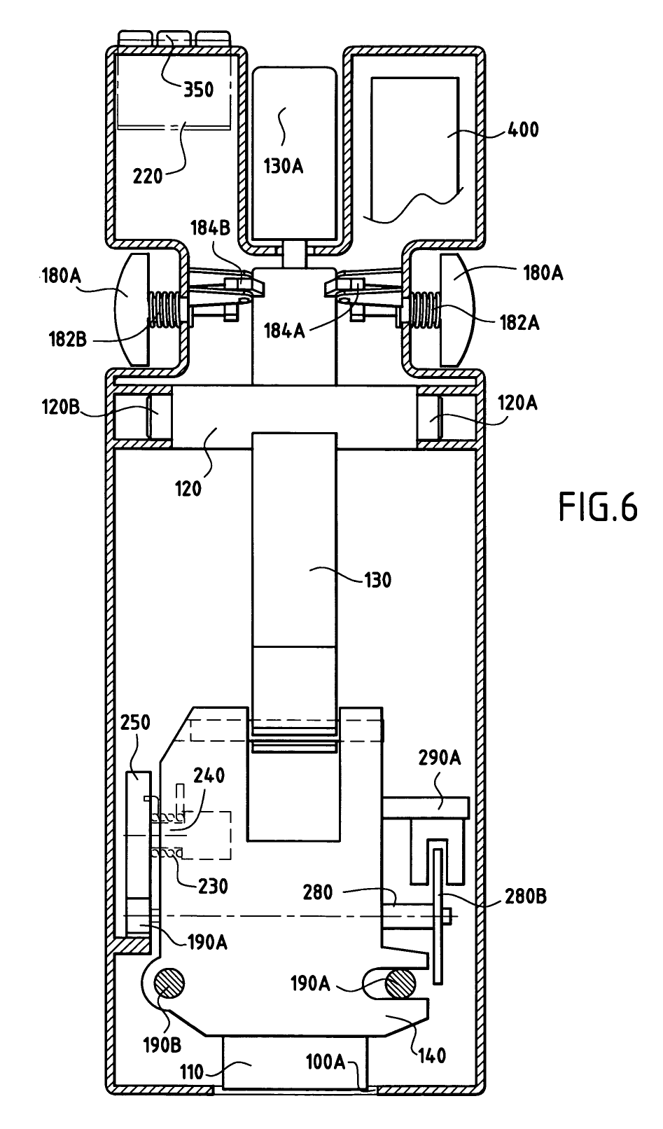

FIGS. 5 and 6 show a second embodiment of an electronic postage marker of the invention. Identical elements are given like references and are not described again below.

The second embodiment differs from the preceding embodiment by the movement of the drive lever 130 which in the second embodiment, is caused to move against a torsion spring 230 mounted on a pin 240 which is secured to the support carriage 140 and at the end of which a first toothed wheel 250 is mounted that meshes with a second toothed wheel 260 itself in engagement with a rack 270 that extends inside the housing parallel to the longitudinal guides 190A, 190B. The second toothed wheel 260 is mounted on one end of a pin 280 at the opposite end of which a screen-printed coding wheel 290B is fastened that serves to co-operate with an optical coder 290A to define the position of the print means as they move inside the housing.

The structure of the processor means 210 is described below with reference to FIG. 7. The processor means incorporate hardware and software means necessary to receive and process the print instructions coming directly or otherwise from the personal computer 20 or from the postage meter 22, depending on the architecture used for the connection of the electronic postage marker and shown in FIGS. 1 and 2.

Said processor means are organized around a microprocessor or microcontroller 300 that is clocked internally by a crystal resonator and that conventionally includes program memory means 310 of the read-only memory (ROM) type, of the electrically-erasable programmable read-only memory (EEPROM) type, or of an analogous type, data memory means 320 of the random access memory (RAM) type or of an analogous type, and interface means for interfacing with the various input/output elements. The program memory means contain the instructions necessary for controlling the print means. The data memory means are at least in part of the backed-up type for storing secure accounting means that are characteristic of any postage meter, in particular down-counters and up-counters, and for temporarily storing the data to be printed. A keypad interface 330 and a screen interface 340 are provided to enable the microcontroller to interact respectively with a keypad 350 for controlling the marker and with the display screen 220 of said marker. The keypad is advantageously constituted merely by a few function keys making it possible, for example, to access scroll-down menus on the screen. The screen can be a liquid crystal diode (LCD) screen making it possible to display the data to be printed in “what you see is what you print” manner.

Similarly, in order to monitor and control the print means, an interface 360 for interfacing with the position coding means 200, 290 is provided, as is an interface 370 for interfacing with said print means 110. The processor means also include a communications interface 380 for communicating with a wireless communications module 390 that incorporates various communications protocols, and radio transceiver means 10A and/or infrared transceiver means 10B.

Finally, a set of advantageously rechargeable batteries 400 provides the power supply for the set of components forming the processor means and the power supply necessary for activating the ink ejection nozzles.

The operating principle of the electronic postage marker of the invention is based on printing data available from its memory means 320 and input, prior to printing, via its keypad (in association with its screen 220) or else received, via its communications module 390, from the remote server 12, in particular over the Internet, from the computer 20, or from the postage meter 22.

In a first embodiment, the memory means 320 contain unchanging image data that merely needs to be filled in via the keypad. For example, in a minimal configuration suitable for individual use, after having chosen a background stamp from the background stamps available in said memory means, it suffices merely to enter a postage amount in order to print a postal imprint, since the date of franking, and the other postal or image data associated with the postal imprint is set automatically on the basis of data internal to the processor means and in synchronization with the clock data of the microcontroller. Once the printing has been done, the accounting means are updated, within the limit of the credit granted to the user. Once said credit has been used up, it is possible, as is known, to issue new credit to the marker from the remote computer server at which the user has a private account. Similarly, the user can change the print means when the level of ink is insufficient for further printing, or can recharge the batteries when they are too flat for powering the postage marker. All of these operations are naturally indicated and monitored on the display screen.

In a second embodiment, the set of data to be printed is received via the communications module 390 using a secure communications protocol which is described in detail below with reference to Figure B.

Firstly, in a first step 500, checking is performed at the postage marker in order to check various items of status data such as sufficient quantity of ink present, ejection nozzles not blocked, power supply voltage of the rechargeable batteries correct, etc. Then, in a step 502, an authentication code for authenticating the is postage marker, which code is pre-recorded during manufacture thereof, is transmitted (via the transmission means of the communications module) to the device to which it can be connected, e.g. the computer or the postage meter, for authentication of the postage marker. In a following step 504, and on the basis of said code and of a master key in the possession of the device, said device then generates a secret key which then serves to sign (or indeed to encipher) all of the communications between the device and the postage marker. The generation algorithm is advantageously of the known Triple Data Encryption Standard (Triple DES) type. The secret key is then sent to the postage marker in a step 506 for comparison with a secret key internal to said postage marker that is generated during manufacture thereof. If the two keys are not identical, the process is terminated, and only non-postal data such as an address or a slogan or indeed other non-secure information (mini-die overprints, for example, in Germany or in Canada) can be printed using the postage marker but postal imprints but under no circumstances can postal imprints be printed. Conversely, in the event that the two keys are identical, then, in another step 508, a predetermined set of postal and image data is transmitted in secure manner (using the same signing or enciphering process) from the device to the postage marker. The image data includes, in particular, images relating to standard stamp backgrounds that differ depending on the country in question. The postal data transmitted, advantageously in compressed form (using a standard compression algorithm) also differs depending on the country in question, but it includes at least a postage value, a franking date, and a contract number. In addition to these minimum items of data, the following items of data can also be communicated: a postage meter number, a post code or “ZIP” code, a matrix authentication code, a check code, a category of object, an up-counter or down-counter value, a clock time, etc. Once decompressed (if necessary), and once signature validation or deciphering has been performed on it, this data is converted, in a step 510, into additional image data, and, in a next step 512, the postal imprint is printed while incorporating said additional image data coming from the postal data and the initial image data. In a step 514, after the printing, the postage marker sends a signed report to the device to which it is connected, and positions itself in a standby step 516 waiting for a printing operation to take place again, the printing operations succeeding one another until the credit of the user is used up. Once said credit is used up, a re-crediting procedure can be undertaken as above. However, it should be noted that, unlike in the preceding embodiment, the accounting means do not have to be disposed in the postage marker. Since the marker is continuously linked to a computer or to a postage meter, said means can be disposed in those devices to which the marker is connected.

What is claimed is:

1. An electronic postage marker for printing data on a mail item, said electronic postage marker comprising:
a substantially rectangular housing body provided with an opening in one of its side faces;
disposable ink jet print means disposed in said housing body for spraying droplets of ink through said opening onto the mail item;
displacement means disposed inside said housing casing for displacing said print means along said opening;
position coding means disposed in said housing body for determining the position of said print means along said opening;
processor means disposed in said housing body for controlling the print means as a function of the position of the displacement means and of said data to be printed on said mail item;
said processor means comprising:
communications means for receiving, in secure manner, said data to be printed;
decoder means for decoding the data to be printed that is received at said communications means;
program memory means for storing control instructions for controlling the print means; and
data memory means for temporarily storing said data to be printed that is received, prior to printing;
display means for displaying the data to be printed before it is printed on said mail item;
data input means for acting in association with said display means to confirm the commands from said processor means; and
rechargeable power supply means disposed in said housing.

2. An electronic postage marker according to claim 1, wherein said data memory means are of the backed-up type and includes secure accounting means, in particular a down-counter and an up-counter.

3. An electronic postage marker according to claim 1, wherein said data to be printed is chosen from the following data: postal imprint, slogan, destination address, authentication data, service data, or any other image data.

4. An electronic postage marker according to claim 1, wherein said decoder means comprise means for deciphering said received data on the basis of a secret key stored in the processor means.

5. An electronic postage marker according to claim 1, wherein said decoder means comprise means for validating a signature accompanying said received data, on the basis of a secret key stored in the processor means.

6. An electronic postage marker according to claim 1, wherein said communications means comprise radiofrequency long-distance wireless communications means.

7. An electronic postage marker according to claim 1, wherein said communications means comprise infrared or radiofrequency short-distance wireless communications means.

8. An electronic postage marker according to claim 1, wherein said position coding means comprise an optical coder serving to co-operate with a screen-printed coding wheel or strip.

9. An electronic postage marker according to claim 1, wherein said display means comprise a liquid crystal graphics screen.

10. An electronic postage marker according to claim 1, wherein said data input means comprise a keypad having at least three keys for running the following functions: next, back, and confirm.
